(19) United States
(12) Patent Application Publication
(10) Pub. No.: US 2026/0370107 A1
(43) Pub. Date: Nov. 19, 2026

(54) Rotary Machine And Method For Balancing The Rotor Thereof, Computer Program

(71) Applicant: ELECTRICITE DE FRANCE, Paris (FR)

(72) Inventor: Mohamed-Amine Hassini, Châtenay-Malabry (FR)

(73) Assignee: ELECTRICITE DE FRANCE, Paris (FR)

(21) Appl. No.: 19/133,956

(22) PCT Filed: Dec. 4, 2023
(86) PCT No.: PCT/EP2023/084117

§ 371 Date: May 29, 2025

(30) Foreign Application Priority Data
Dec. 5, 2022 (FR) FR2212784

(51) Int. Cl. H02K 15/165; H02K 7/08; H02K 7/18; H02K 15/12

(52) U.S. Cl. CPC H02K 15/165; H02K 7/083; H02K 15/12; H02K 7/1823; H02K 2215/00

(57) ABSTRACT

The invention relates to a method for balancing the rotor of a rotary machine, characterised by a rotor balancing controller (6) capable of adjusting the heating power, the method comprising the following steps (EIO, E20, E30), for, at each iteration k: • measuring, by means of the sensor (4), an amplitude Vₖ of a vibration V of the rotor (3) and a phase αₖ of the vibration V; • identifying a value Hₖ of the adjustment parameter H and a value ßₖ of the adjustment parameter ß, which are located in the stable region (101) of the prescribed stability map, for which Fᵣ<I, by means of the controller (6); and • applying the heating power Pₖ, by means of the thermal treatment head (7) via the controller (6), to the rotor in the presence of the vibration V measured by the sensor (4).

The invention relates to a rotating machine as well as to a method for balancing the rotor of the rotating machine.

The field of the invention relates to all types of rotating machines, in particular high-power rotating machines, such as steam turbines, hydraulic turbines and primary motorpump units in the nuclear power plants for electricity production. The examples of rotating machines indicated are non-limiting.

One of the problems with the rotating machines is that they are subject to vibrations when the rotor of the machine rotates relative to its stator.

The invention seeks to reduce, or even eliminate, these vibrations.

Several defects can cause a rotor to vibrate excessively. Mechanical unbalance (or imbalance) of the rotor is the most widespread defect, as it is impossible to manufacture a perfect rotor, that is to say a rotor with a homogeneous distribution of the mass about its axis of rotation. Indeed, a non-homogeneous distribution creates a centrifugal force field that causes the vibration of the machine. In addition to unwanted noise, these vibrations can cause the deterioration of the sealing and the premature fatigue of the mechanical components constituting the rotating machine, such as ball bearings, couplings or bearing supports. The rotors of the rotating machine are normally balanced during the manufacturing phase to minimize the mass imbalance about the axis of rotation and keep the vibrations at acceptable amplitudes. Unfortunately, in some machines, the unbalance can change over time during operation, leading to excessive vibrations. This change can be caused by erosion, cavitation phenomena, corrosion, fouling, the effect called “Newkirk” effect, or the effect called “Morton” effect.

The cavitation is a phenomenon caused by the depression of a liquid below its saturation vapor pressure. Vapor bubbles then form transiently before imploding in a manner that can be so violent that the pressure and the temperature inside the bubble can reach several thousand bars and several thousand degrees Celsius. The implosion also generates a shock wave in the liquid that can erode the solid surfaces, thereby causing a loss of mass that generates the creation of the mechanical unbalance.

The corrosion results from the chemical reaction of a material constituting a rotating part (rotor, blade, disk, etc.) of the machine with an oxidant. This reaction alters the composition of the material and can cause material loss (this is the case of the trailing edges of the blades), consequently leading to the creation of the mechanical unbalance.

The Newkirk effect refers to the vibrations induced by the deformation of the rotor following its asymmetrical heating. The heating is created by the friction between the rotor and a fixed part, for example between the rotor and a seal. This phenomenon can become unstable and lead to vibrations that increase continuously over time. Conventional balancing methods cannot solve the problem posed by the Newkirk effect.

The Morton effect refers to the vibrations induced by the deformation of the rotor following its asymmetrical heating. The heating is created by the shearing of the oil in the hydrodynamic bearings. There is then a coupling between the vibrations of the rotor and the amount of heat generated by shear. This coupling can be unstable, similar to the Newkirk effect. The conventional balancing methods cannot solve the problem posed by the Morton effect.

When the imbalance generates an unacceptable level of vibration, it is necessary to balance the rotor.

A traditional method for balancing the rotor consists in adding and/or subtracting masses at specific axial positions of the rotor in order to achieve a symmetrical mass distribution about the axis of rotation. The drawback of the traditional method is that it is costly and time-consuming, resulting in significant downtime because the addition and/or the removal of masses requires the shutdown of the machine. In addition, the traditional method allows balancing the rotor only for a limited set of operation conditions. For example, the vibratory behavior of a steam turbine depends heavily on the rotation speed, on the power generated, on the temperature of the water source provided to the turbine (water temperature of the river, sea or ocean, which varies according to the seasons), on the temperature of the steam and on its quality. More specifically, the centrifugal force generated by the mass imbalance about the axis of rotation varies with the rotation speed of the rotor. In most cases, the balancing is carried out at a single rotation speed, which is often the nominal rotation speed, which is the operating speed of the rotating machine. The correction necessary to reduce the vibrations at the nominal speed may intensify the vibrations at other operation speeds (for example that of a wind turbine) or during the transients of increases and decreases of the rotation speeds.

As an example, the balancing of the turbo-alternator unit of a nuclear power plant is considered. This rotating machine is composed of several rigidly coupled rotors. Each rotor is balanced after machining at the manufacturer. The assembly of the rotors on the operating site generates an imbalance due to imperfections in the coupling. To correct this type of defect, balancing is performed at the rotors' nominal rotation speed of 1,500 revolutions per minute. In many cases, the correction of the defect at the nominal speed does not reduce the vibrations at other rotation speeds. In addition, the improvement provided by the balancing is only effective for a given power or condenser vacuum pressure. Indeed, the characteristics of the aerodynamic flow (pressure, humidity and temperature) of the steam depend on the pressure of the condenser vacuum. The modification in temperature and the thermomechanical deformations of the rotor modify the distribution of the masses about the axis of rotation. In addition, the erosion of the turbine vanes or the change in the thermal state of the machine lead to an imbalance that changes slowly over time. Consequently, the balancing must be carried out when the thermal state of the machine is stabilized. Achieving a stabilized thermal state requires several hours or even several days of operation due to the very high thermal inertia of the rotors. Given these constraints, the use of the conventional method above leads to very high unavailability of the turbine and forces the operator to use the machine with a set of parameters of the rest of the installation close to those observed during the balancing, which adversely impacts the maneuverability of the machine when it comes for example to modify these parameters in order to adapt the generated power to the demand of the electrical grid (load following). Indeed, the maneuverability will become an increasingly important issue with the introduction of the intermittent renewable energies, requiring leaving the set of nominal parameters.

Thus, according to the conventional method, today, in the vast majority of cases, the correction of the mass imbalance about the axis of rotation is performed by adding masses or removing masses at specific axial positions of the rotor. These axial positions are called balancing planes, as these planes normally intersect the axis of rotation. When it exists, a balancing plane most often consists of a set of holes uniformly distributed about the axis of rotation. Masses are placed in these balancing holes to correct the imbalance. The number of holes and the way in which the balancing planes are placed along the rotor have a direct influence on the quality of the balancing of the machine.

These known methods require multiple shutdowns and start-ups of the machine, which are expensive and time-consuming to implement. In addition, these known methods allow balancing the rotor only for a limited set of operation conditions. Furthermore, these known methods have the drawback of being intrusive within the rotor. Moreover, document FR-A-2 303 277 discloses a balancing device for a rotating machine including, in order to balance the rotor while it is in operation by imposing a deformation thereon by asymmetric thermal effect, a sensor able to detect an imbalance of the rotor and a signal transducer associated with this sensor, an energy source, capable of using a laser beam, able to deliver unilateral energy pulses to a chosen portion of the rotor to cause asymmetric heating thereof, and a control device transmitting the signals from said sensor to the energy source for the purpose of adjusting the angular positions of the energy pulses relative to the rotor, the frequency of these energy pulses being in an integer ratio with the speed of the rotor.

The balancing device known from document FR-A-2 303 277 however poses the following problem.

The balancing device known from document FR-A-2 303 277 is empirical and does not provide a calculative method to correctly adjust the heating performed by the energy source in order to achieve the balancing of the rotor. Thus, a drawback of the latter is that the adjustment of the heating of the energy source is not accurate, leading to uncertainties in achieving the balancing of the rotor. This device cannot solve the problem of the vibrations that would be induced by the Newkirk effect or the Morton effect.

The problem, however, is that it is sought to improve the accuracy and speed of the adjustment of the energy source, leading more reliably to the balancing of the rotor.

One objective of the invention is to obtain a rotating machine, as well as a method for balancing the rotor thereof, which make it possible to balance the rotor in order to reduce its vibrations when it rotates, by solving the problem mentioned above and by overcoming the drawbacks mentioned above.

To this end, a first subject matter of the invention is a method for balancing the rotor of a rotating machine, the rotating machine including a stator, the rotor being able to rotate about an axis of rotation relative to the stator,
the rotating machine including:
at least one rotor vibration sensor, the rotor vibration sensor being mounted on the stator,
at least one heat treatment head, which occupies a determined angular range of less than 360° about the axis of rotation facing the rotor, which is without contact with the rotor and which is able to apply a heating power to the rotor without contact with the rotor in the determined angular range, being mounted on the stator,
at least one sensor of the angular position in rotation of the rotor about the axis of rotation relative to the stator being mounted on the stator,
the rotating machine including a balancing controller for balancing the rotor,
characterized in that
the heating power is a complex number having a positive modulus representing a heating amplitude applied by the at least one heat treatment head, the complex number having an argument representing an angular position at which the heating amplitude is applied by the at least one heat treatment head in the determined angular range,
the balancing controller for balancing the rotor is able to adjust the heating power P=r·H·Ve^{jβ}
where H is an adjustment parameter for an amplitude of a bending moment of the rotor, created by the heat treatment head, and is a real greater than or equal to zero,
ß is an adjustment parameter for a phase of the heating power,
r is a coefficient of bending sensitivity of the rotor to the heating power applied by the heat treatment head, the coefficient r of bending sensitivity being pre-recorded in the balancing controller,
at least one prescribed rotor stability map for at least one determined rotation speed of the rotor about the axis of rotation relative to the stator and for at least one axial position of the heat treatment head, being pre-recorded in the balancing controller and indicating at least one stable area and at least one unstable area for pairs of values of H and ß, the stability map being parameterized by a vibration reduction factor Fᵣ determined at least in the stable area,
the method including at least the following steps, carried out iteratively during the rotation of the rotor about the axis of rotation relative to the stator at the determined rotation speed, in order to, at each iteration k:
during a first step, measure, by the rotor vibration sensor, an amplitude Vₖ of a vibration V of the rotor and a phase αₖ of the vibration V of the rotor relative to a phase reference according to the equation V=Vₖ·e^{j·α}^{ₖ},
during a second step, identify a value Hₖ of the adjustment parameter H and a value ßₖ of the adjustment parameter ß, which are located in the stable area of the prescribed stability map and for which Fᵣ<1, by the balancing controller,
during a third step, apply the heating power Pₖ=r·Hₖ·Vₖ·e^{j·(α}^{ₖ}^{+ß}^{ₖ}⁾ by the heat treatment head via the balancing controller to the rotor and in the presence of the vibration V measured by the rotor vibration sensor.

According to one embodiment of the invention, the coefficient r of bending sensitivity of the rotor to the heating power applied by the heat treatment head is prescribed in the balancing controller as being equal to the ratio of a determined and non-zero real value P₁ of the heating power to a measured or calculated value of the bending moment of the rotor, caused by the application of the real value of the heating power by the heat treatment head via the balancing controller to the rotor.

According to one embodiment of the invention, r·H·V_{K}≤Pₘₐₓ
where Pₘₐₓ is a positive non-zero maximum real value of the heating power.

According to one embodiment of the invention, the rotor is guided in rotation about its axis of rotation relative to the stator by at least two bearings distant from each other along the axis of rotation, the heat treatment head and the rotor vibration sensor being placed between the bearings,
ßₖ=0° for the rotating machine whose rotor has a mass overhanging from one of the bearings, which is smaller than an intermediate mass of the rotor located between the bearings and for the rotating machine operating at a rotation frequency of the rotor, which is greater than a frequency of a first bending mode of the rotor.

According to one embodiment of the invention, the rotor is guided in rotation about its axis of rotation relative to the stator by at least two bearings distant from each other along the axis of rotation, the heat treatment head and the rotor vibration sensor being placed between the bearings,
ßₖ=180° for the rotating machine whose rotor has a mass overhanging from one of the bearings, which is smaller than an intermediate mass of the rotor located between the bearings and for the rotating machine operating at a rotation frequency of the rotor, which is smaller than a frequency of a first bending mode of the rotor.

According to one embodiment of the invention, the first step, the second step and the third step are carried out iteratively for at least one previous iteration k and at least one following iteration k+1, in order to, during the second step of the following iteration k+1:
adjust by the balancing controller the value Hₖ₊₁ of the adjustment parameter H such that

$${H}_{k + 1} = \frac{γ {P}_{ma x}}{r \cdot {V}_{k + 1}} ,$$

where
Vₖ₊₁ is the amplitude of the vibration V of the rotor, having been measured during the first step of the following iteration k+1,
γ is an iteration adjustment factor, which is a strictly positive real and less than or equal to 1 and which is pre-recorded in the balancing controller,
and identify by the balancing controller the value ßₖ₊₁ of the adjustment parameter ß from the prescribed stability map making it possible to obtain the smallest value of the vibration reduction factor Fᵣ among a finite set of determined values of the vibration reduction factor Fᵣ.

According to one embodiment of the invention, γ=1.

According to one embodiment of the invention, the first step, the second step and the third step are carried out iteratively for at least one previous iteration k and at least one following iteration k+1 until the value Hₖ₊₁ of the adjustment parameter H of the following iteration k+1 reaches a prescribed threshold Hₘₐₓ, in order to:
during the second step of the following iteration k+1, adjust by the balancing controller the value Hₖ₊₁ of the adjustment parameter H and the value ßₖ₊₁ of the adjustment parameter ß, with Hₖ₊₁ equal to a prescribed function, increasing as a function of time up to the prescribed threshold Hₘₐₓ,
apply during the third step of the following iteration k+1, by the heat treatment head via the balancing controller to the rotor and in the presence of the vibration V measured by the rotor vibration sensor, the heating power

Pₖ₊₁=r·Hₖ₊₁·Vₖ₊₁·e^{j·(α}^{ₖ₊₁}^{+ß}^{ₖ₊₁}⁾
where Vₖ₊₁ is the amplitude of the vibration V of the rotor, having been measured during the first step of the following iteration k+1.

According to one embodiment of the invention, the prescribed increasing function is a linear ramp increasing as a function of time up to the prescribed threshold Hₘₐₓ or an affine ramp increasing as a function of time up to the prescribed threshold Hₘₐₓ.

According to one embodiment of the invention, the method further includes the following steps, carried out by the balancing controller before the first step, the second step and the third step:
identifying a pair of a target value H_{c} of the adjustment parameter H and of a target value ß_{c} of the adjustment parameter ß, which is located in the stable area of the prescribed stability map and which gives the smallest value of the vibration reduction factor Fᵣ, strictly less than 1, among a finite set of determined values of the vibration reduction factor Fᵣ,
identifying a pair of a starting value H_{d} of the adjustment parameter H and of a starting value ß_{d} of the adjustment parameter ß, which is located in the stable area of the prescribed stability map and for which the vibration reduction factor Fᵣ is strictly less than 1, the starting value H_{d} of the adjustment parameter H being smaller than the target value H_{c} of the adjustment parameter H,
identifying in the prescribed stability map a path going from the pair of H_{d} and ß_{d} to the pair of H_{c} and ß_{c} by successive pairs of the values of Hₖ and ßₖ, which are located in the stable area of the prescribed stability map,
the first step, the second step and the third step being carried out iteratively for the successive pairs of the values of Hₖ and ßₖ to go from the pair of H_{d} and ß_{d} to the pair of H_{c} and ß_{c}.

According to one embodiment of the invention, the method further includes, before the first step, the second step and the third step, a step of choosing a total, non-zero duration, tₘ to go from the pair of H_{d} and ß_{d} to the pair of H_{c} and ß_{c}, carried out by the balancing controller.

According to one embodiment of the invention, the first step, the second step and the third step are carried out iteratively for at least one previous iteration k and at least one following iteration k+1, in order to:
if k=0 or Vₖ₊₁>Vₖ, identify by the balancing controller during the second step of the following iteration k+1 the value Hₖ₊₁ of the adjustment parameter H and the value βₖ₊₁ of the adjustment parameter ß, which are located in the stable area of the prescribed stability map,
and otherwise identify by the balancing controller during the second step of the following iteration k+1 the value Hₖ₊₁ of the adjustment parameter H and the value βₖ₊₁ of the adjustment parameter ß with Hₖ₊₁=Hₖ and ßₖ₊₁=ßₖ.

According to one embodiment of the invention, the rotating machine includes m rotor vibration sensors cᵢ which are mounted on the stator, where m is a natural number greater than or equal to 2 and i is an integer ranging from 1 to m,
the method further includes the following steps, before the first, second and third steps:
during a first preparatory step, measuring a complex vibration measurement vector

$${Q}_{d} = {\{ {q}_{{d}_{i}} {e}^{j γ {a}_{i}} \}}^{T}$$

by the m rotor vibration sensors cᵢ, where q_{d}_{ᵢ} is the amplitude of the vibrations of the rotor measured respectively by the rotor vibration sensor cᵢ and γ_{d}_{ᵢ} is the phase of the vibrations of the rotor measured respectively by the rotor vibration sensor cᵢ,
during a second preparatory step, calculating the prescribed stability map in association with values of the vibration reduction factor Fᵣ by repeating the following sub-steps for each value of H and β located in the stable area of the stability map by the balancing controller:
   calculating Q_{f} being solution of the system of equations:

Ξ·Q_{f}=Q_{d}
with

$${Q}_{f} = {\{ {q}_{{f}_{i}} {e}^{j {γ}_{{f}_{i}}} \}}^{T}$$

calculating the values Fᵣ (H, ß) of the vibration reduction factor Fᵣ such that:

$${F}_{r} ( H , β ) = max ( {\{ \frac{{q}_{{f}_{i}}}{{q}_{{d}_{i}}} \}}_{i ∈ [ 1 , m ]} )$$

where the matrix Ξ is calculated as follows:
   calculating a first matrix A such that A=−M·Ω²+j·Ω·C+K
the rotating machine being represented by a finite element model, including models of finite elements, in which the heat treatment head is located between a node Ng of a machine mesh and a node Nd of the machine mesh and the rotor vibration sensor is located facing a node Nc of the machine mesh,
where M is a prescribed mass matrix of the finite element model of the rotating machine,
C being a prescribed damping matrix of the finite element model of the rotating machine,
K being a prescribed stiffness matrix of the finite element model of the rotating machine,
Ω being the determined rotation speed,
   calculating a second matrix Π of binding of degrees of freedom, the second matrix Π having the following values:
      value 1 in its row tdry1, column tx,
      value j in its row tdry1, column ty,
      value j in its row tdrx1, column tx,
      value −1 in its row tdrx1, column ty,
      value −1 in its row tdry2, column tx,
      value −j in its row tdry2, column ty,
      value −j in its row tdrx2, column tx,
      value 1 in its row tdrx2, column ty,
      0 elsewhere,
where j is the complex number being square root of −1,
X is a first direction perpendicular to the axis of rotation,
Y is a second direction perpendicular to the first direction X and to the axis of rotation,
tx is an index of a translational displacement degree of freedom along the first direction X of the node Nc,
ty is an index of a translational displacement degree of freedom along the second direction Y of the node Nc,
tdrx1 is an index of a rotational displacement degree of freedom around the first direction X of the node Ng,
tdry1 is an index of a rotational displacement degree of freedom around the second direction Y of the node Ng,
tdrx2 is an index of a rotational displacement degree of freedom around the first direction X of the node Nd,
tdry2 is an index of a rotational displacement degree of freedom around the second direction Y of the node Nd,
   calculating a third transition matrix R, having m rows and n columns, where:
i is an index for the rows of the third transition matrix R, as well as respectively for the rotor vibration sensors cᵢ and ranges from 1 to m,
n is a number of degrees of freedom of the finite element model,
tᵢ is an index for the columns of the third transition matrix R, as well as for the displacement degrees of freedom corresponding respectively to the rotor vibration sensors cᵢ, for ranging from 1 to m,
the third transition matrix R having the following values:
R(i, tᵢ)=1 for i ranging from 1 to m,
0 elsewhere,
   calculating the matrix E, having m rows and n columns, where:

Ξ=R·(I−H·e^{jβ}·A⁻¹·Π)

where A⁻¹ is the inverse matrix, having been calculated, of the first matrix A.

A second subject matter of the invention is a rotating machine including:
a stator,
a rotor able to rotate about an axis of rotation relative to the stator, at least one rotor vibration sensor, the rotor vibration sensor being mounted on the stator,
at least one heat treatment head, which occupies a determined angular range of less than 360° about the axis of rotation facing the rotor, which is without contact with the rotor and which is able to apply a heating power to the rotor without contact with the rotor in the determined angular range, being mounted on the stator,
at least one sensor of the angular position in rotation of the rotor about the axis of rotation relative to the stator being mounted on the stator,
a balancing controller for balancing the rotor,
characterized in that
the heating power being a complex number having a positive modulus representing a heating amplitude applied by the at least one heat treatment head, the complex number having an argument representing an angular position at which the heating amplitude is applied by the at least one heat treatment head in the determined angular range,
the balancing controller for balancing the rotor is able to adjust the heating power P=r·H·Ve^{jβ}
where H is an adjustment parameter for an amplitude of a bending moment created by the heat treatment head and is a real greater than or equal to zero,
ß is an adjustment parameter for a phase of the heating power,
r is a coefficient of bending sensitivity of the rotor to the heating power applied by the heat treatment head, the r of bending sensitivity being pre-recorded in the balancing controller,
at least one prescribed rotor stability map for at least one determined rotation speed of the rotor about the axis of rotation relative to the stator and for at least one axial position of the heat treatment head, being pre-recorded in the balancing controller and indicating at least one stable area and at least one unstable area for pairs of values of H and ß, the stability map being parameterized by a vibration reduction factor Fᵣ determined at least in the stable area,
the balancing controller for balancing the rotor and the rotor vibration sensor being configured to implement at least the following steps, carried out iteratively during the rotation of the rotor about the axis of rotation relative to the stator at the determined rotation speed, in order to, at each iteration k:
during a first step, measure, by the rotor vibration sensor, an amplitude Vₖ of a vibration V of the rotor and a phase αₖ of the vibration V of the rotor relative to a phase reference according to the equation V=Vₖ·e^{j·α}^{ₖ},
during a second step, identify a value Hₖ of the adjustment parameter H and of a value ßₖ of the adjustment parameter ß, which are located in the stable area of the prescribed stability map and for which Fᵣ<1, by the balancing controller,
during a third step, apply the heating power Pₖ=r·Hₖ·Vₖ·e^{j·(α}^{ₖ}^{+β}^{ₖ}⁾ by the heat treatment head via the balancing controller to the rotor and in the presence of the vibration V measured by the rotor vibration sensor.

A third subject matter of the invention is a computer program, including code instructions for the implementation of at least the second step and the third step of the method for balancing the rotor of a rotating machine as described above, when the computer program is executed on a controller.

The invention will be better understood upon reading the following description, given solely by way of non-limiting example with reference to the figures below of the appended drawings.

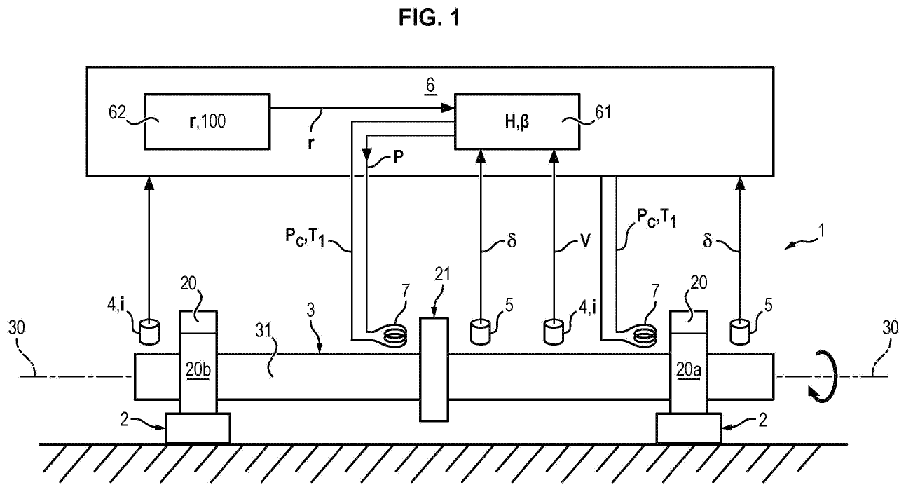

FIG. 1 represents a schematic front view of a rotating machine according to one embodiment of the invention.

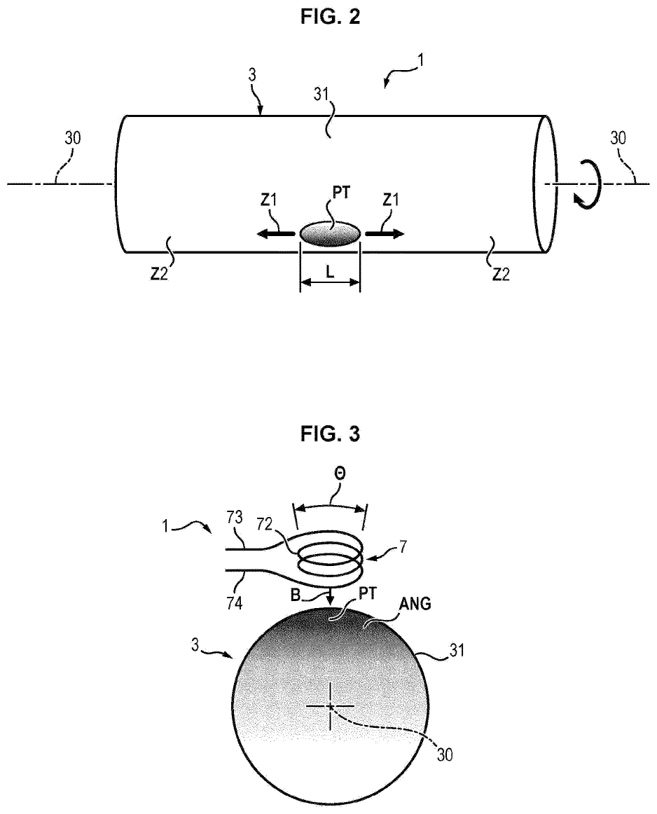

FIG. 2 represents a schematic front view of the rotor of the rotating machine according to one embodiment of the invention.

FIG. 3 represents a schematic side view of a rotating machine according to one embodiment of the invention.

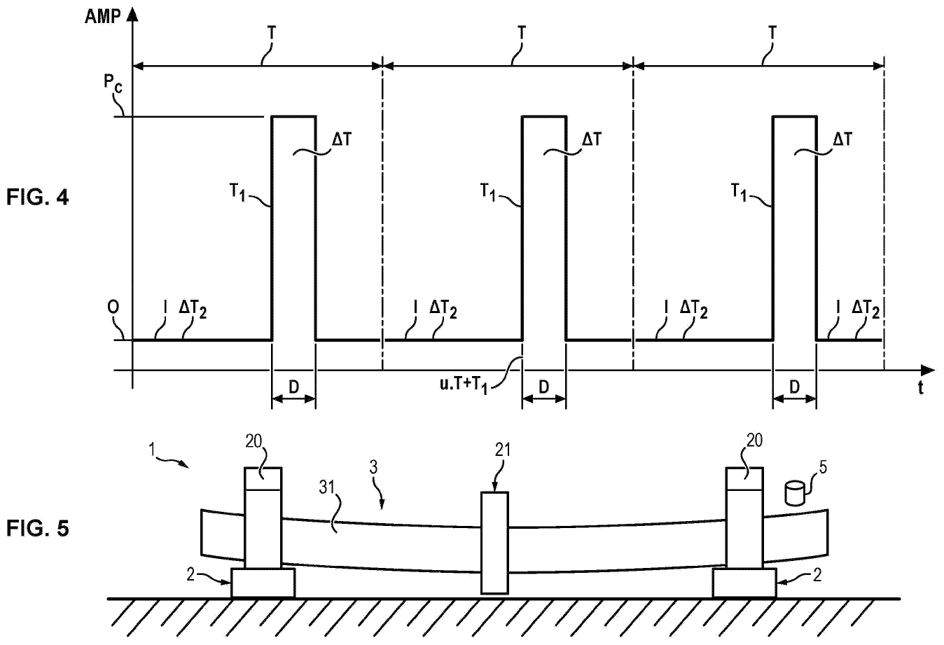

FIG. 4 represents a timing diagram of the activation time of a treatment head in the rotating machine according to one embodiment of the invention.

FIG. 5 represents a schematic front view of a deformation caused by a temperature differential on the rotating machine according to one embodiment of the invention.

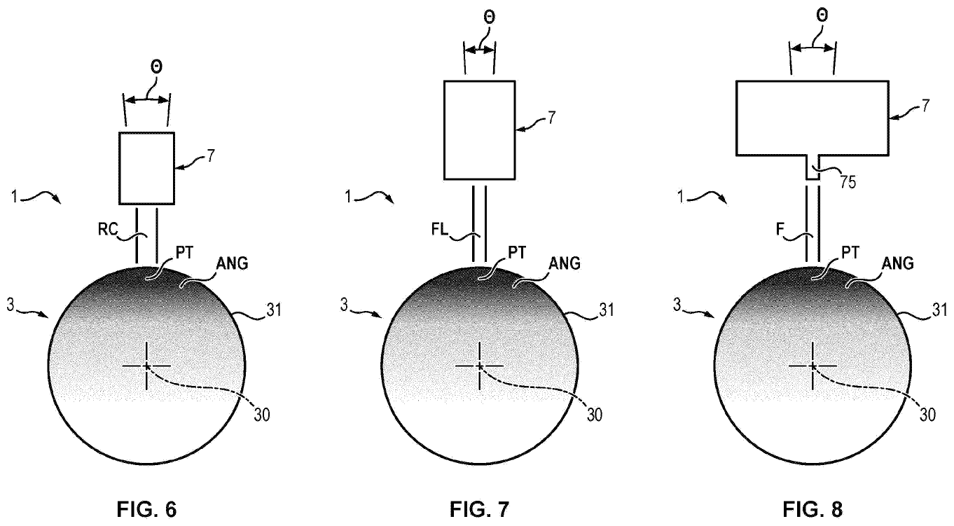

FIG. 6 represents a schematic side view of a rotating machine according to one embodiment of the invention.

FIG. 7 represents a schematic side view of a rotating machine according to one embodiment of the invention.

FIG. 8 represents a schematic side view of a rotating machine according to one embodiment of the invention.

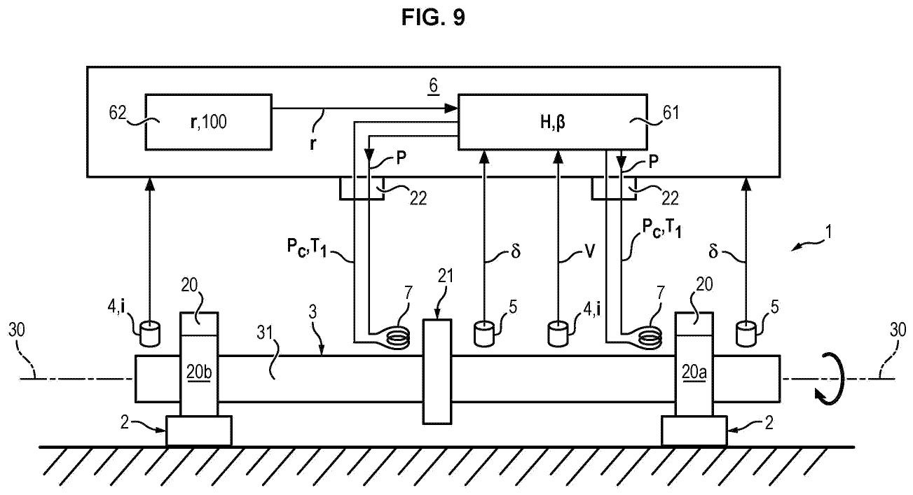

FIG. 9 represents a schematic front view of a rotating machine according to one embodiment of the invention.

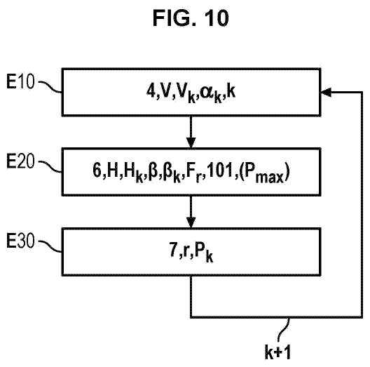

FIG. 10 represents a flowchart of the balancing method according to the invention.

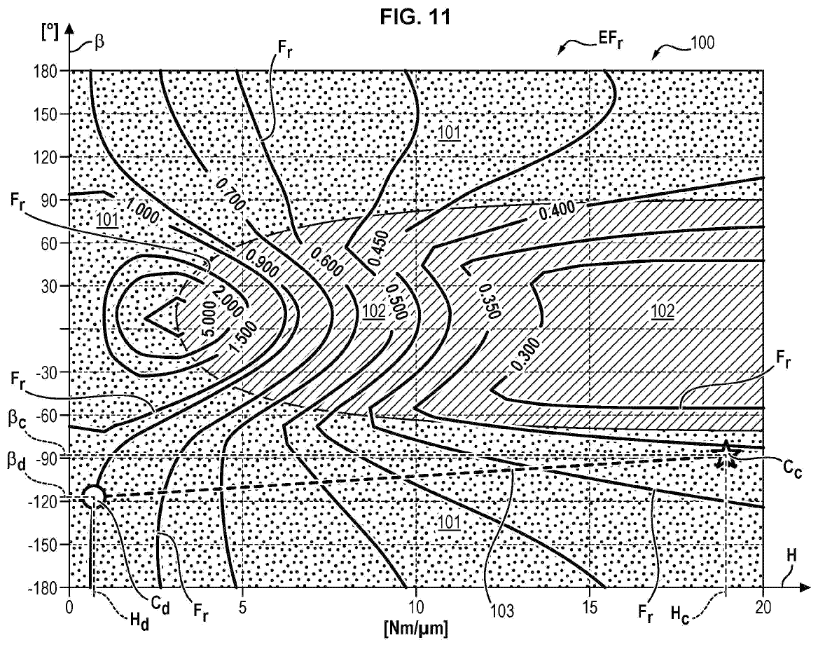

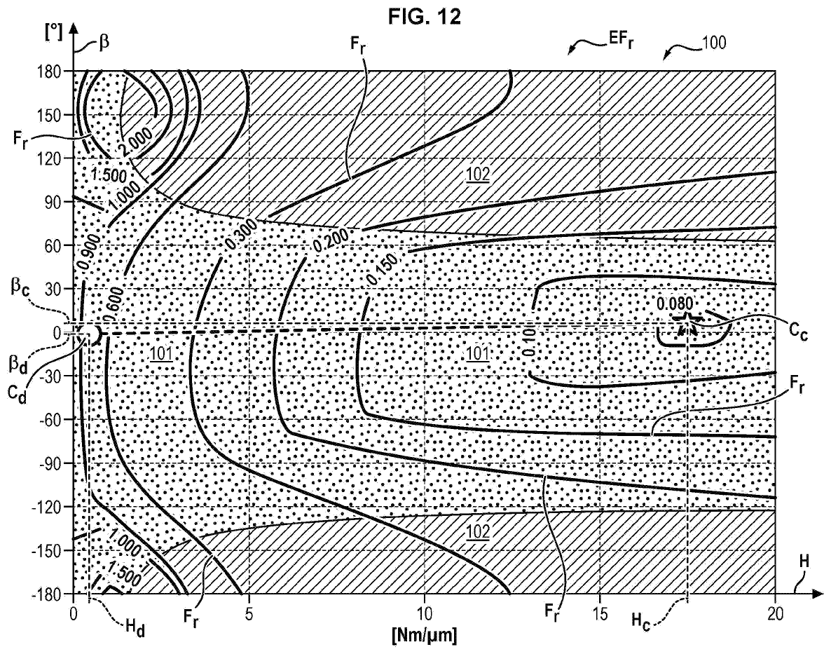

FIG. 11 represents one example of a stability map used in the balancing method according to the invention.

FIG. 12 represents another example of a stability map used in the balancing method according to the invention.

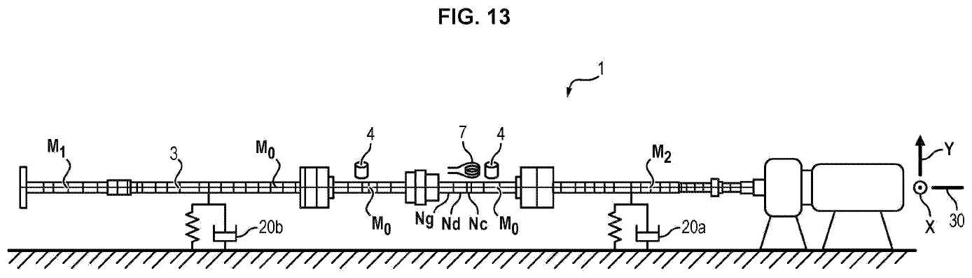

FIG. 13 represents one example of a finite element model used in the balancing method according to the invention.

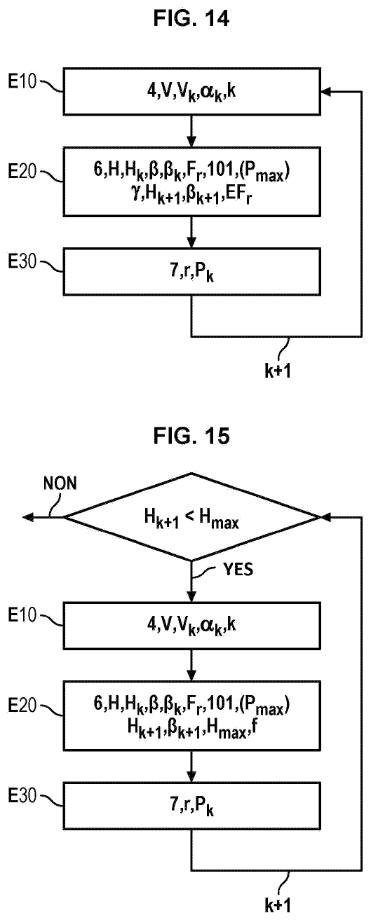

FIG. 14 represents a flowchart of a first embodiment of the balancing method according to the invention.

FIG. 15 represents a flowchart of a second embodiment of the balancing method according to the invention.

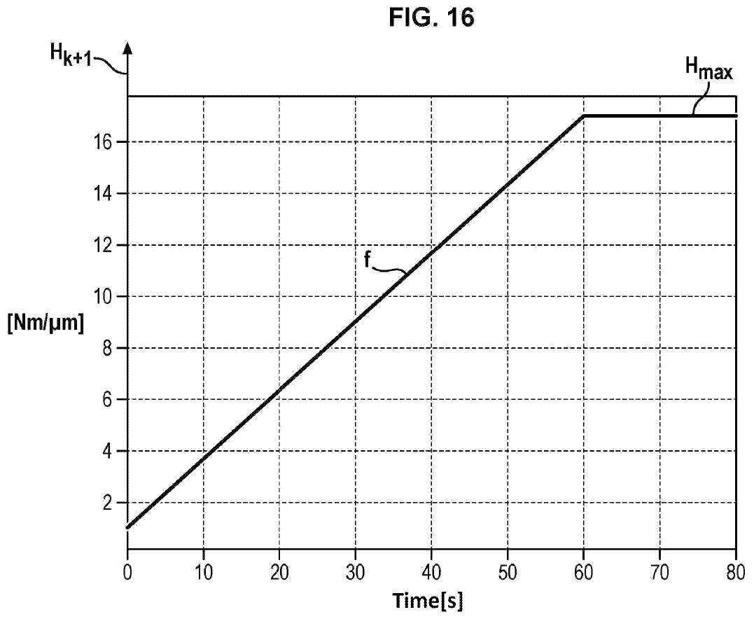

FIG. 16 represents one example of a function that can be used in the second embodiment of the balancing method according to the invention.

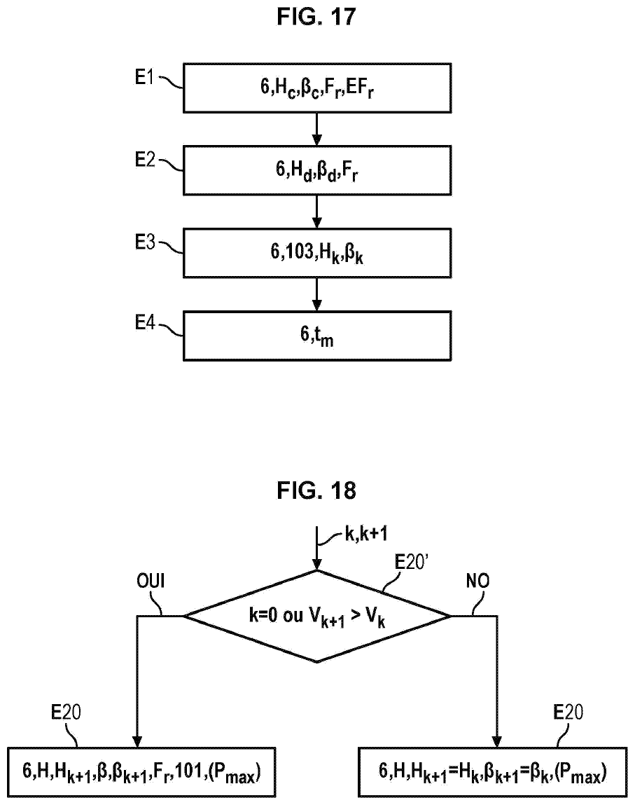

FIG. 17 represents a flowchart of a third embodiment of the balancing method according to the invention.

FIG. 18 represents a flowchart of a fourth embodiment of the balancing method according to the invention.

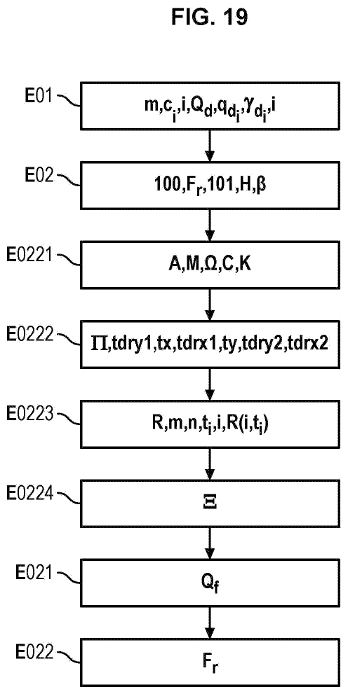

FIG. 19 represents a flowchart of a fifth embodiment of the balancing method according to the invention.

In FIGS. 1, 2, 3, 6, 7, 8 and 9, the rotating machine 1 according to the invention includes a stator 2 and a rotor 3 able to rotate relative to the stator 2 about an axis of rotation 30 of this rotor 3. The stator may include one or more first electrical winding(s) distributed about the axis 30. The stator 2 is considered to be the fixed part of the rotating machine 1 and may include elements other than the first electrical windings, such as a frame or the like. The rotor 3 includes a shaft rotatable about the axis of rotation 30 and may include one or more magnetic element(s) and/or second electrical winding(s), distributed about the axis 30 and fixed to the shaft. The rotor 3 is guided in rotation about its axis 30 by one or more bearing(s) 20 fixed to the stator 2. The rotor 3 may have one or more disk(s) 21 fixed to the shaft.

In a first case, the rotating machine 1 may operate as an electricity generator, that is to say, the rotor 3 is able to be fixed to a source of mechanical rotation, driving the rotor 3 in rotation about the axis 30 to generate electric current in the first electrical windings of the stator 2. The rotation of the rotor 3 induces a variable magnetic field through its rotated magnetic elements and/or second electrical windings. The variable magnetic field induces an electrical voltage called electromotive force across the terminals of the first windings of the stator 4. The stator 4 induces one or more phase(s), each having one or more terminal(s) for connection with the outside, to provide to the outside the electric current produced in the first electrical windings of the stator 4 when the rotor 3 is rotated about the axis 30. The rotating machine operating as an electricity generator can be used in an electricity production plant. The source of mechanical rotation can be for example a turbine for a rotating generator machine 1 formed by an alternator or a turbo-alternator. The source of mechanical rotation can be an electric motor, this is the case of a primary motor pump unit of a nuclear power plant for electricity production. The source of mechanical rotation can be actuated by hydraulic energy, for example in a hydraulic power plant for electricity production. The source of mechanical rotation can be a combined-cycle gas turbine.

In a second case, the rotating machine 1 can operate as a motor, that is to say, the variable electric current sent from the outside to the first electrical windings of the stator 2 drives in rotation the rotor 3 about the axis 30 via the magnetic elements and/or second electrical windings of the rotor 3.

One (or more) vibration sensor(s) 4 is/are fixed to the stator 2 to provide vibration measurements of the rotor 3. Each sensor has a determined position on the stator 2. The sensor(s) 4 allow measuring the vibrations in the radial direction of the rotor 3. The sensors 4 can be distributed in different positions along the axis of rotation 30 and can be aligned along a direction parallel to the axis of rotation 30. The sensors 4 can be distributed about the axis of rotation 30. The measured vibrations can be displacements, speeds or accelerations. The vibration sensor 4 can be a displacement sensor, an acceleration sensor, a speed sensor or the like. N refers to the number of vibration sensors 4 used.

The stator 2 includes one (or more) sensor(s) 5 of the instantaneous angular position δ in rotation of the rotor 3 about the axis of rotation 30 relative to the stator 2. This sensor 5 of the angular position δ in rotation of the rotor 3 can measure the elapsed time from a time reference and can use the period T necessary for the rotor 3 to perform a complete rotation about the axis 30, to determine at each instant t the instantaneous angular position δ of the rotor 2 from the deviation between this instant and this period T, the angular position δ returning for example to zero at each elapsed period. When this sensor 5 measures the angular position of the rotor, it is called multi-top-turn. If the sensor 5 only measures the instants between which the rotor performs a complete rotation, it is called “top-turn”. The sensor 5 allows making the link between the phase of the vibration signals and the angular position of the rotor 3. The sensor 5 also allows measuring the period of rotation and consequently the rotation speed of the rotor.

According to the invention, the stator 2 includes one (or more) heat treatment head(s) 7, which occupy a determined angular range θ (non-zero) of less than 360° about the axis of rotation 30, wherein the determined angular range θ faces the rotor 3. The heat treatment head 7 is located at a predetermined, non-zero distance from the circumference 31 of the rotor 3. The heat treatment head 7 may be at a distance from or nearby the bearing(s) 20 or any part of the stator 2 surrounding the rotor 3 about the axis of rotation 30. The rotor 3 extends lengthwise along the axis of rotation 30 and may have, for example and without limitation, a length of several meters. The heat treatment head 7 is not in contact with the rotor 3 and faces the rotor 3.

The machine 1 includes a controller 6 for balancing the rotor 3 by the heat treatment head 7. The vibration sensor 4, the angular position sensor 5 and the heat treatment head 7 are connected to the controller 6. The rotor 3 balancing controller 6 may be or comprise one (or more) calculator(s) 61, one (or more) computer(s), one (or more) processor(s), one (or more) microprocessor(s), one (or more) microcontroller(s), one (or more) actuator(s), one (or more) permanent memory(ies) 62, one (or more) non-permanent memory(ies) 62, one (or more) computer program(s).

The invention is described below with reference to FIGS. 1, 9 and 10 to 19.

The heat treatment head(s) 7 is/are able to apply a heating power P to the rotor 3. The heat treatment head(s) 7 is/are therefore a contactless heating head 7.

In the following, since the heat treatment head(s) 7 is/are one (or more) heating head(s) 7, the heating power and the angular position at which the heating is applied are represented by a single complex number, the modulus of which is the (positive) heating amplitude applied by the heat treatment head(s) 7 and the argument of which is the angular position at which the heating amplitude is applied by the heat treatment head(s) 7.

The rotor 3 balancing controller 6 is configured to adjust the heating power P such that P=r·H·Ve^{jβ}=Pₖ=r·Hₖ·Vₖ·e^{j·(α}^{ₖ}^{+β}^{ₖ}⁾

The complex notation of P=Pₖ=r·Hₖ·Vₖ·e^{j·(α}^{ₖ}^{+β}^{ₖ}⁾ means: apply an amplitude heating of rHVₖ to the angular position αₖ+βₖ. This is a mathematical notation that splits two pieces of information into the same complex number: heating amplitude and the angular position at which this heating is applied. In no case does the heating become negative.

Equivalently, the complex notation P=rHVe^{jβ} means: apply a heating whose amplitude is the product of r, H, and the amplitude of the vibration V. This heating is to be applied at the angular position given by the sum of the angle β and the argument of V.

H and ß are two adjustment parameters for the heating power P of the heat treatment head(s) 7.

H is an adjustment parameter for an amplitude of the bending moment created by the heat treatment head 7 and is a real greater than or equal to zero, whose unit is N·m/m (bending moment per unit length). The adjustment parameter H for the amplitude of the bending moment created by the heat treatment head 7 is calculated by the balancing controller 6.

ß is an adjustment parameter for a phase of the heating power P. The adjustment parameter ß for the heating power phase P is calculated by the balancing controller 6.

r is a coefficient of the bending sensitivity of the rotor 3 to the heating power applied by the heat treatment head 7 and is pre-recorded in the memory 62 of the balancing controller 6. The coefficient of the bending sensitivity of the rotor 3 to the heating power applied by the heat treatment head 7 is prescribed to the balancing controller 6. This coefficient r of the bending sensitivity of the rotor 3 can be equal to the ratio

$$r = \frac{{P}_{1}}{{M}_{1}}$$

of a determined and non-zero real value P₁ of the heating power P to a value M₁ of the bending moment of the rotor 3, which has been measured or calculated and which is caused by the application of the real value P₁ of the heating power P by the heat treatment head 7 via the balancing controller 6 to the rotor 3. Of course, the coefficient r of the bending sensitivity of the rotor 3 to the heating power applied by the heat treatment head 7 could be different from this ratio and depend on other functions of P₁ and M₁.

V is a vibration of the rotor 3, measured by the vibration sensor(s) 4.

The adjustment parameter H for the bending sensitivity of the rotor 3 can be calculated by the balancing controller 6 such that r·H·Vₖ≤Pₘₐₓ, where Pₘₐₓ is a positive non-zero maximum real value of the heating power P. Of course, the adjustment parameter H for the bending sensitivity of the rotor 3 could be different.

As represented by way of example in FIGS. 11 and 12, one (or more) prescribed rotor 3 stability map(s) 100 for one (or more) determined rotation speed(s) of the rotor 3 about the axis of rotation 30 relative to the stator 2 and for one (or more) axial position(s) of the heat treatment head 7 along the axis of rotation 30 is/are pre-recorded in the balancing controller 6 (in the memory 62). The prescribed stability map 100 comprises one (or more) stable area(s) 101 for pairs of values of H and ß and one (or more) unstable area(s) 102 for pairs of values of H and ß. For example, in FIGS. 11 and 12, the stable area(s) 10 of the stability map 100 and the unstable area(s) 102 of the stability map 100 are represented as a function of the values of H on the abscissa and as a function of the values of ß on the ordinate (of course, this could also be the other way around). A stable area is an area in which the amplitude of the vibrations converges towards a constant value. An unstable area is an area in which the amplitude of the vibrations increases indefinitely.

A vibration reduction factor Fᵣ determined at least in the stable area(s) 101 for the pairs of values of H and ß, is also pre-recorded in the stability map 100 (in the memory 62). The vibration reduction factor Fᵣ is therefore also a parameter of the stability map 100. For example, in FIGS. 11 and 12, the vibration reduction factor Fᵣ is represented by lines of constant value (or level line) as a function of some values of H and ß. There may be, as represented in FIGS. 11 and 12, lines of constant value of the vibration reduction factor Fᵣ, which are located partly in the stable area 101 and partly in the unstable area 102 (as shown in FIGS. 11 and 12), and/or lines of constant value of the vibration reduction factor Fᵣ, which are located entirely in the stable area 101 (as shown in FIG. 12), and/or lines of constant value of the vibration reduction factor Fᵣ, which are located entirely in the unstable area 102 (as shown in FIG. 11). There may be in the prescribed stability map 100, as represented in FIGS. 11 and 12, lines of constant value of the vibration reduction factor Fᵣ, which are greater than one, a line of constant value of the vibration reduction factor Fᵣ which is equal to one, and lines of constant value of the vibration reduction factor Fᵣ which are less than one.

FIG. 10 represents a flowchart of the method for balancing the rotor 3 of the rotating machine 1 according to the invention.

The balancing method according to the invention includes the following steps E10, E20, E30, which are carried out at each iteration k during the rotation of the rotor 3 about the axis of rotation 30 relative to the stator 2 at the determined rotation speed.

During the first step E10 of each iteration k, the vibration sensor(s) 4 measure(s) an amplitude Vₖ of the vibration V of the rotor 3 and a phase αₖ of the vibration V of the rotor 3 relative to a phase reference according to the equation V=Vₖ·e^{j·α}^{ₖ}.

During a second step E20 subsequent to the first step E10, the balancing controller 6 identifies a value Hₖ of the adjustment parameter H and a value ßₖ of the adjustment parameter ß, which defines a point located in the stable area 101 of the prescribed stability map 100 in the or one of the stable areas 101 of the prescribed stability map 100. This value Hₖ of the adjustment parameter H and this value ßₖ of the adjustment parameter ß are chosen by the balancing controller 6 in the stable area 101 of the prescribed stability map 100 so that the corresponding vibration reduction factor Fᵣ in the prescribed stability map 100, corresponding to this value Hₖ of the adjustment parameter H and to this value ßₖ of the adjustment parameter ß, is smaller than 1.

During a third step E30 subsequent to the second step E20, the balancing controller 6 controls the heat treatment head 7 so that the heat treatment head 7 sends (without contact) the heating power Pₖ=r·Hₖ·Vₖ·e^{j·(α}^{ₖ}^{+β}^{ₖ}⁾ in the presence of the vibration V measured by the vibration sensor 4 on the rotor 3.

This allows quickly injecting this heating power Pₖ into the rotor 3 to counteract the vibrations, without having to wait for the vibrations to stabilize. The invention thus makes it possible to solve the problem of the vibrations that would be induced by the Newkirk effect or the Morton effect.

In first and second examples of application of the invention, represented in FIG. 13, the rotor 3 is guided in rotation about its axis of rotation 30 relative to the stator 2 by two (or more than two) bearings 20a and 20b distant from each other along the axis of rotation 30. In these first and second examples, the heat treatment head 7 and the vibration sensor 4 are placed between the bearings 20a and 20b. In these first and second examples, the rotor 3 of the machine 1 has a mass M₁ overhanging to the left of the left bearing 20b, which is smaller than the intermediate mass M₀ of the rotor 3 located between the left bearing 20b and the right bearing 20a. In these first and second examples, the rotor 3 of the machine 1 has a mass M₂ overhanging to the right of the right bearing 20a, which is smaller than the intermediate mass M₀ of the rotor 3 located between the left bearing 20b and the right bearing 20a.

In the first example where the rotor 3 rotates about the axis of rotation 30 at a rotation frequency higher than a frequency of a first bending mode of the rotor 3 (or critical frequency), the balancing controller 6 chooses the value ßₖ=0° of the adjustment parameter ß during the second step E20. This first example corresponds for example to FIG. 12. In the example of FIG. 12, the rotation frequency of the rotor 3 is equal to 1,500 revolutions per minute.

In the second example where the rotor 3 rotates about the axis of rotation 30 at a rotation frequency lower than a frequency of a first bending mode of the rotor 3 (or critical frequency), the balancing controller 6 chooses the value ßₖ=180° of the adjustment parameter ß during the second step E20. This second example corresponds for example to FIG. 11. In the example of FIG. 11, the rotation frequency of the rotor 3 is equal to 1,200 revolutions per minute.

In a first embodiment of the invention, represented in FIG. 14, the first, second, and third steps E10, E20, E30 are carried out iteratively for at least one previous iteration k and at least one following iteration k+1, so that, during the second step E20 of the following iteration k+1, the balancing controller 6 adjusts the value Hₖ₊₁ of the adjustment parameter H such that

$${H}_{k + 1} = \frac{γ {P}_{m ax}}{r \cdot {V}_{k + 1}} .$$

Vₖ₊₁ is the amplitude of the vibration V of the rotor 3, having been measured during the first step E10 of the following iteration k+1.

γ is an iteration adjustment factor, which is a strictly positive real less than or equal to 1 and which is pre-recorded in the balancing controller 6 (memory 62). The iteration adjustment factor γ is therefore prescribed to the balancing controller 6. For example, the iteration adjustment factor γ may be equal to 1. Of course, the iteration adjustment factor γ may be other than 1.

The balancing controller 6 identifies, during the second step E20 of the following iteration k+1, the value βₖ₊₁ of the adjustment parameter ß from the prescribed stability map 100 and selects the smallest value of the vibration reduction factor Fᵣ among a finite set EFᵣ of determined values of the vibration reduction factor Fᵣ. This finite set EFᵣ of determined values of the vibration reduction factor Fᵣ has been pre-recorded in the balancing controller 6 (memory 62). This allows for the fastest possible vibration reduction that can be achieved with the heat treatment head 7.

In a second embodiment of the invention, represented in FIG. 15, the first, second and third steps E10, E20, E30 are carried out iteratively for at least one previous iteration k and at least one following iteration k+1 until the value Hₖ₊₁ of the adjustment parameter H of the following iteration k+1 reaches a prescribed threshold Hₘₐₓ.

During the second step E20 of the following iteration k+1, the balancing controller 6 adjusts the value Hₖ₊₁ equal to a prescribed function f, this function f increasing as a function of time up to the prescribed threshold Hₘₐₓ. During the second step E20 of the following iteration k+1, the balancing controller 6 adjusts the value ßₖ₊₁ of the adjustment parameter ß.

During the third step E30 of the following iteration k+1, the balancing controller 6 controls the heat treatment head 7 so that the heat treatment head 7 sends (without contact) the heating power Pₖ₊₁=r·Hₖ₊₁·Vₖ₊₁·e^{j·(α}^{ₖ₊₁}^{+β}^{ₖ₊₁}⁾ to the rotor 3 in the presence of the vibration V measured by the vibration sensor 4. Vₖ₊₁ is the amplitude of the vibration V of the rotor 3, having been measured during the first step E10 of the following iteration k+1.

For example, as represented in FIG. 16, the prescribed increasing function f is a linear ramp increasing as a function of time up to the prescribed threshold Hₘₐₓ or an affine ramp increasing as a function of time up to the prescribed threshold Hₘₐₓ.

In a third embodiment of the mention, represented in FIG. 17, the balancing controller 6 further carries out the following steps E1, E2, E3 before the first, second and third steps E10, E20, E30.

During step E1, the balancing controller 6 identifies, in the or one of the stable areas 101 of the prescribed stability map 100, a pair C_{c} of a target value H_{c} of the adjustment parameter H and of a target value ß_{c} of the adjustment parameter ß, which gives the smallest value of the vibration reduction factor Fᵣ, strictly less than 1, among a finite set EFᵣ of determined values of the vibration reduction factor Fᵣ, as represented by way of examples in FIGS. 11 and 12.

During step E2, the balancing controller 6 identifies, in the or one of the stable areas 101 of the prescribed stability map 100, a pair C_{d} of a starting value H_{d} of the adjustment parameter H and of a starting value ß_{d} of the adjustment parameter ß, for which the vibration reduction factor Fᵣ is strictly less than 1, as represented by way of examples in FIGS. 11 and 12.

The starting value H_{d} of the adjustment parameter H can for example be smaller than the target value H_{c} of the adjustment parameter H. This allows reducing the power required to perform the balancing.

During step E3, subsequent to steps E1 and E2, the balancing controller 6 identifies, in the or one of the stable areas 101 of the prescribed stability map 100, a path 103 going from the starting pair C_{d} of H_{d} and ß_{d} to the target pair C_{c} of H_{c} and ß_{c}, this path 103 passing through the successive pairs of the values of Hₖ and ßₖ, which are located in the or one of the stable areas 101 of the prescribed stability map 100, as represented by way of examples in FIGS. 11 and 12.

The first, second and third steps E10, E20, E30 are carried out iteratively for the successive pairs of the values of Hₖ and ßₖ of this path 103 to go from the starting pair C_{d} of H_{d} and ß_{d} to the target pair C_{c} of H_{c} and ß_{c}.

During a step E4, the balancing controller 6 can further choose a total non-zero duration tₘ to go from the starting pair C_{d} of H_{d} and ß_{d} to the target pair C_{c} of H_{c} and ß_{c} by the successive pairs of the values of Hₖ and ßₖ.

In a fourth embodiment of the mention, represented in FIG. 18, the first, second and third steps E10, E20, E30 are carried out iteratively for at least one previous iteration k and at least one following iteration k+1. The balancing controller 6 examines during the iterations whether k=0 or Vₖ₊₁>Vk (step E20′ in FIG. 18). In the case where k=0 or Vₖ₊₁>Vₖ, (case YES in FIG. 18), the balancing controller 6 identifies during the second step E20 of the following iteration k+1 the value Hₖ₊₁ of the adjustment parameter H and the value βₖ₊₁ of the adjustment parameter ß, which are located in the or one of the stable areas 101 of the prescribed stability map 100. In the case where k=0 or Vₖ₊₁>Vₖ are not verified (case NO in FIG. 18), the balancing controller 6 identifies during the second step E20 of the following iteration k+1 the value Hₖ₊₁ of the adjustment parameter H and the value βₖ₊₁ of the adjustment parameter ß with Hₖ₊₁=Hₖ and ßₖ₊₁=ßₖ.

In a fifth embodiment of the invention, represented in FIG. 19, the machine includes m sensors cᵢ of vibrations of the rotor 3 (sensors 4) which are mounted on the stator 2. The natural number m is greater than or equal to 2 and i is an integer ranging from 1 to m.

The method further includes the following steps, before the first, second and third steps E10, E20, E30.

During a first preparatory step E01, the m vibration sensors cᵢ measure the complex vibration measurement vector

$${Q}_{d} = {\{ {q}_{{d}_{i}} {e}^{j {γ}_{{d}_{i}}} \}}^{T}$$

for i ranging from 1 to m. The vibration sensor cᵢ measures the vibration

$${q}_{{d}_{i}} {e}^{j {γ}_{{d}_{i}}}$$

forming the component i of this measured vector Q_{d}, where the amplitude q_{d}_{ᵢ} of the vibrations of the rotor 3 is measured respectively by the vibration sensor cᵢ and the phase γ_{d}_{ᵢ} of the vibrations of the rotor 3 is measured respectively by the vibration sensor cᵢ.

During a second preparatory step E02, the balancing controller 6 calculates the prescribed stability map 100 in association with values of the vibration reduction factor Fᵣ by repeating the following sub-steps E021, E022 for each value of H and β located in the stable area 101 of the stability map 100.

During the sub-step E021, the balancing controller 6 calculates the vector Q_{f}, solution to the system of equations:

Ξ·Q_{f}=Q_{d}
with

$${Q}_{f} = {\{ {q}_{{f}_{i}} {e}^{j {γ}_{{f}_{i}}} \}}^{T}$$

for i ranging from 1 to m.

During the sub-step E022, the balancing controller 6 calculates the values Fᵣ(H, ß) of the vibration reduction factor Fᵣ such that

$${F}_{r} ( H , β ) = max ( {\{ \frac{{q}_{{f}_{i}}}{{q}_{{d}_{i}}} \}}_{i ∈ [ 1 , m ]} )$$

Prior to sub-step E021, the balancing controller 6 calculates the matrix Ξ of the sub-step E021 by carrying out the following other steps E0221, E0222, E0223 and E0224.

During step E0221, the balancing controller 6 calculates a first matrix A such that A=−M·Ω²+j·Ω·C+K.

As represented by way of example in FIG. 13, the balancing controller 6 calculates a finite element model representing the machine 1, in which the heat treatment head 7 is located between a node Ng of a mesh of the machine 1 and a node Nd of the mesh of the machine 1 and in which the vibration sensor 4 is located facing a node Nc of the mesh of the machine 1.

M is a prescribed mass matrix of the finite element model of the machine 1 and is pre-recorded in the balancing controller 6 (memory 62). The model can be a one-dimensional finite element model along the axis of rotation 30, as represented for example in FIG. 13.

C is a prescribed damping matrix of the finite element model of the machine 1 and is pre-recorded in the balancing controller 6 (memory 62).

K being a prescribed stiffness matrix of the finite element model of the machine 1 and is pre-recorded in the balancing controller 6 (memory 62).

Ω is the rotation speed, and can be either prescribed or measured by the sensor 5.

During step E0222, the balancing controller 6 calculates a second matrix Π of binding of degrees of freedom, the matrix Π having the following values:
value 1 in its row tdry1, column tx,
value j in its row tdry1, column ty,
value j in its row tdrx1, column tx,
value −1 in its row tdrx1, column ty,
value −1 in its row tdry2, column tx,
value −j in its row tdry2, column ty,
value −j in its row tdrx2, column tx,
value 1 in its row tdrx2, column ty,
0 elsewhere,
where j is the complex number, which is square root of −1. The matrix II is a sparse matrix (due to the presence of 0s).

X is a first direction perpendicular to the axis of rotation 30.

Y is a second direction perpendicular to the first direction X and to the axis of rotation 30.
tx is the index of the translational displacement degree of freedom along the X direction of the node Nc,
ty is the index of the translational displacement degree of freedom along the Y direction of the node Nc,
tdrx1 is the index of the rotational displacement degree of freedom around the X direction of the node Ng,
tdry1 is the index of the rotational displacement degree of freedom around the Y direction of the node Ng,
tdrx2 is the index of the rotational displacement degree of freedom around the X direction of the node Nd,
tdry2 is the index of the rotational displacement degree of freedom around the Y direction of the node Nd.

During step E0223, the balancing controller 6 calculates a third transition matrix R, having m rows and n columns, where:
i is the index for the rows of the matrix R, as well as respectively for the sensors cᵢ of vibrations of the rotor 3 and ranges from 1 to m,
n is the number of degrees of freedom of the finite element model,
tᵢ is the index for the columns of the matrix R, as well as for the displacement degrees of freedom corresponding respectively to vibration sensors cᵢ of the rotor 3 for i ranging from 1 to m. Generally, R is the transition matrix that matches the values of the digital model to those measured by the vibration sensors.

The balancing controller 6 calculates the third transition matrix R having the following values:
R(i, tᵢ)=1 for i ranging from 1 to m,
0 elsewhere. The matrix R is a sparse matrix (due to the presence of 0s).

During step E0224, the balancing controller 6 calculates the matrix Ξ, having m rows and n columns, where

Ξ=R·(I−H·e^{jβ}·A⁻¹·Π),
A⁻¹ being the inverse matrix, having been calculated by the balancing controller 6, of the matrix A.
I is the identity matrix.

According to one embodiment of the invention, the stability map 100 is predetermined by the balancing controller 6 using the finite element model. The balancing controller 6 can calculate the stability map 100 in the following manner.

For each pair of values H and β, the balancing controller 6 calculates the eigenvalues ν of the fourth matrix Ψ mentioned below:

Ψ=(H·e^{jβ}·A⁻¹·Π−I)
where I is the identity matrix of the same size as A. The matrices A and Π have already been defined above.

If the real values [symbol] of all the eigenvalues ν of the fourth matrix Ψ are strictly negative, then the pair H, β is said to be stable and is located in the stable area 101.

Mathematically, the stability condition is written:

max{ [symbol] (ν) such that det(Ψ−ν·I)=0}<0}

where det refers to the determinant, max denotes the maximum.

If this condition is not met, then the pair H, β is said to be unstable and is located in the unstable area 102.

The invention also relates to the rotating machine 1 including the stator 2 equipped with the vibration sensor(s) 4, the rotor 3 described above, the heat treatment head 7 described above, the angular position sensor(s) 5 described above and the balancing controller 6 configured to implement the steps described above.

The invention also relates to a computer program including code instructions for the implementation of at least the second and third steps E20, E30 of the method for balancing the rotor 3 of the rotating machine 1 as described above, when the computer program is executed on the balancing controller 6 described above.

In a sixth embodiment, not represented, the vibration reduction factor Fᵣ can be determined in a manner other than the fifth embodiment. For example, the balancing controller 6 can calculate the vibration reduction factor Fᵣ of the prescribed stability map 100 by measuring, using the sensor 5, the first amplitude Q_{eq} of the vibrations V obtained for each heating power P mentioned above (that is to say for each pair of H and ß adjusted by the balancing controller 6 on the heat treatment head 7) during the rotation of the rotor 3, and by dividing this first amplitude Q_{eq} by the second amplitude Q₀ of the vibrations V measured by the sensor 5 in the absence of this heating power P during the rotation of the rotor 3, that is to say Fᵣ=Q_{eq}/Q₀.

The third embodiment can be combined with the first embodiment or with the second embodiment.

The fourth embodiment can be combined with the first embodiment or with the second embodiment or with the third embodiment.

The fifth embodiment can be combined with the first embodiment or with the second embodiment or with the third embodiment or with the fourth embodiment.

The sixth embodiment can be combined with the first embodiment or with the second embodiment or with the third embodiment or with the fourth embodiment.

Other embodiments which can be combined with each of the embodiments and examples described above are described below.

According to one embodiment of the invention, represented in FIG. 3, the heat treatment head 7 is configured to apply the heating power to a part PT of the circumference 31 of the rotor 3, located facing the determined angular range θ during the rotation of the rotor 2 about the axis 30, as represented by way of example in FIG. 2. The determined angular range θ may be relatively narrow. According to one embodiment, the determined angular range θ may be less than or equal to 180° or 90°, in particular less than or equal to 45°, or less than or equal to 20°, or less than or equal to 5°, or less than or equal to 1°. The determined angular range θ is greater than 0°, in particular greater than or equal to 0.1° or to 0.5°.

According to one embodiment of the invention, represented in FIG. 2, the heat treatment head 7 occupies a determined (non-zero) length L parallel to the axis of rotation 30 facing the rotor 3 and is able to apply the heating power to the rotor 3 without contact with the rotor 3 in the determined length L. The determined length L is greater than zero and for example greater than 5 mm.

According to one embodiment of the invention, represented in FIG. 4, the rotor 3 balancing controller 6 is configured to adjust at least one instant of activation T₁ of the contactless heating power of the heat treatment head 7 and/or at least one duration of activation D of the contactless heating power of the heat treatment head 7 from the instant of activation T₁ and/or an amplitude P_{c} of the heating power of the heat treatment head 7 as a function at least of the instantaneous angular position δ having been measured by the angular position sensor 5 of the rotor 3. The controller 6 for balancing the rotor 3 can control the heat treatment head 7 by a pulsed control signal. The amplitude P_{c} of the heating power can be in pulse form as a function of time t, as illustrated by way of example in FIG. 4.

According to one embodiment, the balancing controller 6 makes it possible to adjust the duration of activation D of the heating power towards the rotor 3 during each period of rotation T of the rotor 3 about the axis 30. The head 7 controlled by the controller therefore applies, in the determined angular range θ and during the duration of activation D, the heating power to the circumference 31 of the rotor 3. The controller 7 therefore controls the heat treatment head 7 to apply the heating power to a localized area PT of the circumference 31 of the rotor 3. The controller 6, from the analysis of the vibrations recorded by the vibration sensor(s) 4, calculates the heating power, its duration D, as well as the angular sector ANG of the rotor 3 where the heating power is to be applied.

For example, as illustrated in FIG. 4, the duration of activation D of the non-zero amplitude P_{c} of the contactless heating power of the heat treatment head 7 from the instant of activation T₁ is smaller than the period of rotation T of the rotor 3 to complete a 360° turn about the axis of rotation 30 relative to the stator 2. FIG. 4 shows the amplitude AMP of the heat treatment sent by the head 7 on the ordinate as a function of the time t on the abscissa. Thus, in the example of FIG. 4, the duration of activation D of the contactless heating power of the heat treatment head 7 at the non-zero amplitude P_{c} from the instant of activation T₁ is followed or preceded during the period of rotation T by a duration of inactivation I of the head 7 so as not to apply heating power to the rotor 3 at zero amplitude or by a duration of application I of a second heating power ΔT₂ having an amplitude smaller than the amplitude P_{c} of duration D. The balancing controller 6 can be configured to perform pulse width modulation of the heating power.

According to one embodiment of the invention, the heat treatment head 7 therefore makes it possible to heat treat a determined angular sector ANG less than 360°, of the circumference 31 of the rotor 3 in rotation about the axis 30, having the duration D smaller than the period of rotation T of the rotor 3, the period of rotation T being the time taken by the rotor 3 to complete a 360° turn about the axis of rotation 30. For example, the instant of activation T₁ of the contactless heating power of the heat treatment head 7 is periodic with the same period as the period of rotation T and/or the duration of activation D of the contactless heating power of the heat treatment head 7 from the instant of activation T₁ is periodic with the same period as the period of rotation T. This angular sector ANG of the rotor 3 corresponds in these cases to the duration of activation D of the contactless heating power of the heat treatment head 7 from the instant of activation T₁, extends over ANG=360°·D/T, starting at the angular position of the rotor 360°·T₁/T which corresponds to the instant u·T+T₁ after the start u·T of each period of rotation T, where u is a natural number. This makes it possible to always treat the same angular sector ANG of the circumference 31 of the rotor 2 by the head 7 during successive rotations of the rotor 3 about the axis 30. Of course, in other embodiments, the instant T₁ and the duration D could not be periodic.

According to one embodiment of the invention, the heat treatment head 7 is a contactless heating head 7. In this case, the head 7 increases the temperature of the circumference 31 of the rotor 3 in the determined angular range θ, and the heating power (then called hot spot) in the part PT of the circumference 31 of the rotor 3 (angular sector ANG) is positive and not zero. The heat treatment head 7 therefore sends heat in the determined angular range θ and in the part PT (angular sector ANG) of the circumference 31 of the rotor 3. In the example illustrated in FIG. 2, the part PT located facing the contactless heating head 7 is heated by this contactless heating head 7 and is the hottest area PT of the circumference 31 of the rotor 3. The fibers of the material constituting the rotor 3 in the areas Z1 located in the vicinity of this part PT heated by the heating head 7 will expand more than the areas Z2 far from the part PT heated by the heating head 7 on the rotor 3. The material of the rotor 3 in the areas Z1 will therefore tend to move more than the material of the rotor 3 in the areas Z2 by moving away from the heating point PT located facing the heating head 7, thus creating a tension of the parts Z1 close to the heating area PT. This tensioning is not homogeneous along the circumference 31 of the rotor 3 and will therefore cause a bending of the rotor 3 as illustrated in FIG. 5. The bending thus created will generate a new distribution of the mass about the axis 30 of the rotor 3. By controlling the amplitude P_{c} and the angular position ANG of the heated portion PT, it is possible to modify the distribution of the mass about the axis of rotation 30 and thus to generate dynamic forces making it possible to oppose the forces generated by the defects of the rotor 3. The heating of the rotor 3 is carried out without any contact and in a non-intrusive manner. If the system is used to correct a mass imbalance of the rotor 3, then the correction is carried out without ever having to stop the rotation of the rotor 3, and without having to modify the rotation of the rotor. The correction can adapt to the rotation speed of the rotor 3 about the axis 30 and to the appearance of new imbalances that would be created by other phenomena, for example the cavitation erosion, the Newkirk effect or the Morton effect.

Different embodiments of this contactless heating head 7 are given below, with reference to FIGS. 3, 6, 7, 8 and 9.

According to one embodiment of the invention, illustrated in FIG. 3, the heat treatment head 7 is a head 7 for emitting a heating magnetic induction in the determined angular range θ towards the rotor 3 and without contact with the rotor 3. The heat treatment head 7 includes one (or more) coil(s) 71 or inductor(s) 71. The coil 71 or inductor 71 is configured to generate a magnetic field B, for example radial relative to the axis of rotation 30, in the determined angular range θ, when the coil 71 or inductor 71 is crossed by an electric current sent by an electric current source of the controller 6 to the two ends 73 and 74 of the coil 71 or inductor 71. This magnetic field B makes it possible to heat the part PT of the circumference 31 of the rotor 3 in rotation about the axis 30. The coil 71 or inductor 71 includes for example one or more turn(s) 72 between the two ends 73 and 74. The axis around which the coil 71 or inductor 71 or turn 72 is wound is normal or has a component normal to the surface 31 of the rotor 3.

According to one embodiment of the invention, illustrated in FIG. 6, the heat treatment head 7 is a head 7 for emitting a heating radiation RC in the determined angular range θ towards the rotor 3 and without contact with the rotor 3. The radiation RC touches the part PT of the circumference 31 of the rotor 3 in rotation about the axis 30. The head 7 for emitting the RC radiation is without contact with the rotor 3.

According to another embodiment of the invention, illustrated in FIG. 7, the heat treatment head 7 is a head 7 for emitting a heating laser beam FL in the determined angular range θ towards the rotor 3. The laser beam FL touches the part PT of the circumference 31 of the rotor 3 in rotation about the axis 30. The head 7 for emitting the laser beam FL is without contact with the rotor 3.

According to one embodiment of the invention, the machine 1 includes a single heat treatment head 7, a single rotor vibration sensor 4 and a single angular position sensor 5 of the rotor 3.

According to another embodiment of the invention, the machine 1 includes several heat treatment heads 7, which are mounted on the stator 2.

According to one embodiment of the invention, illustrated in FIG. 9, a displacement device 22 is mounted on the stator 2 to move the heat treatment head 7 along the axis of rotation 30 and/or about the axis of rotation 30. The displacement device 22 makes it possible to move along the axis of rotation 30 the part PT of the circumference 31 of the rotor 3 (angular sector ANG), to which the heat treatment head 7 applies the contactless heating power, for example to bring this part PT closer to a mass overhanging from the rotor 3.

1. A method for balancing a rotor of a rotating machine, the rotating machine including a stator, the rotor being able to rotate about an axis of rotation relative to the stator,
the rotating machine including:
at least one rotor vibration sensor, the at least one rotor vibration sensor being mounted on the stator,
at least one heat treatment head, which occupies a determined angular range of less than 360° about the axis of rotation facing the rotor, which is without contact with the rotor and which is able to apply a heating power to the rotor without contact with the rotor in the determined angular range, being mounted on the stator,
at least one sensor of a first angular position in rotation of the rotor about the axis of rotation relative to the stator being mounted on the stator,
the rotating machine including a balancing controller for balancing the rotor,
wherein
the heating power is a complex number having a positive modulus representing a heating amplitude applied by the at least one heat treatment head, the complex number having an argument representing a second angular position at which the heating amplitude is applied by the at least one heat treatment head in the determined angular range,
the balancing controller for balancing the rotor is able to adjust the heating power P=r·H·Ve^{jβ}
where H is an adjustment parameter for an amplitude of a bending moment of the rotor, created by the at least one heat treatment head, and is a real greater than or equal to zero,
ß is an adjustment parameter for a phase of the heating power,
r is a coefficient of bending sensitivity of the at least one rotor to the heating power applied by the at least one heat treatment head, the coefficient r of bending sensitivity being pre-recorded in the balancing controller,
at least one prescribed rotor stability map for at least one determined rotation speed of the rotor about the axis of rotation relative to the stator and for at least one axial position of the at least one heat treatment head, being pre-recorded in the balancing controller and indicating at least one stable area and at least one unstable area for pairs of values of H and ß, the at least one prescribed rotor stability map being parameterized by a vibration reduction factor Fᵣ determined at least in the at least one stable area,
the method including at least the following steps, carried out iteratively during the rotation of the rotor about the axis of rotation relative to the stator at the at least one determined rotation speed, in order to, at each at least one previous iteration k:
during a first step, measure, by the at least one rotor vibration sensor, an amplitude Vₖ of a vibration V of the rotor and a phase αₖ of the vibration V of the rotor relative to a phase reference according to the equation V=Vₖ·e^{j·α}^{ₖ},
during a second step, identify a value Hₖ of the adjustment parameter H and a value ßₖ of the adjustment parameter ß, which are located in the at least one stable area of the at least one prescribed rotor stability map and for which Fᵣ<1, by the balancing controller,
during a third step, apply the heating power Pₖ=r·Hₖ·Vₖ·e^{j·(α}^{ₖ}^{+β}^{ₖ}⁾ by the at least one heat treatment head via the balancing controller to the rotor and in the presence of the vibration V measured by the at least one rotor vibration sensor.

2. The method according to claim 1, wherein the coefficient r of bending sensitivity of the rotor to the heating power applied by the at least one heat treatment head is prescribed in the balancing controller as being equal to the ratio of a determined and non-zero real value P₁ of the heating power to a measured or calculated value of the bending moment of the rotor, caused by the application of the real value of the heating power by the at least one heat treatment head via the balancing controller to the rotor.

3. The method according to claim 1, wherein r·H·Vₖ≤Pₘₐₓ
where Pₘₐₓ is a positive non-zero maximum real value of the heating power.

4. The method according to claim 1, wherein the rotor is guided in rotation about its axis of rotation relative to the stator by at least two bearings distant from each other along the axis of rotation, the at least one heat treatment head and the at least one rotor vibration sensor being placed between the bearings,
ßₖ=0° for the rotating machine whose rotor has a mass overhanging from one of the bearings, which is smaller than an intermediate mass of the rotor located between the bearings and for the rotating machine operating at a rotation frequency of the rotor, which is greater than a frequency of a first bending mode of the rotor.

5. The method according to claim 1, characterized in wherein the rotor is guided in rotation about its axis of rotation relative to the stator by at least two bearings distant from each other along the axis of rotation, the at least one heat treatment head and the at least one rotor vibration sensor being placed between the bearings,
ßₖ=180° for the rotating machine whose rotor has a mass overhanging from one of the bearings, which is smaller than an intermediate mass of the rotor located between the bearings and for the rotating machine operating at a rotation frequency of the rotor, which is smaller than a frequency of a first bending mode of the rotor.

6. The method according to claim 1, wherein the first step, the second step and the third step are carried out iteratively for at least one previous iteration k and at least one following iteration k+1, in order to, during the second step of the at least one following iteration k+1:
adjust by the balancing controller the value Hₖ₊₁ of the adjustment parameter H such that
$${H}_{k + 1} = \frac{γ {P}_{m ax}}{r \cdot {V}_{k + 1}} .$$
where
Vₖ₊₁ is the amplitude of the vibration V of the rotor, having been measured during the first step of the at least one following iteration k+1,
γ is an iteration adjustment factor, which is a strictly positive real and less than or equal to 1 and which is pre-recorded in the balancing controller,
and identify by the balancing controller the value βₖ₊₁ of the adjustment parameter ß from the at least one prescribed rotor stability map making it possible to obtain the smallest value of the vibration reduction factor Fᵣ among a finite set of determined values of the vibration reduction factor Fᵣ.

7. The method according to claim 6, wherein γ=1.

8. The method according to claim 1, wherein the first step, the second step and the third step are carried out iteratively for at least one previous iteration k and at least one following iteration k+1 until the value Hₖ₊₁ of the adjustment parameter H of the at least one following iteration k+1 reaches a prescribed threshold Hₘₐₓ, in order to:
during the second step of the at least one following iteration k+1, adjust by the balancing controller the value Hₖ₊₁ of the adjustment parameter H and the value ßₖ₊₁ of the adjustment parameter ß, with Hₖ₊₁ equal to a prescribed function, increasing as a function of time up to the prescribed threshold Hₘₐₓ,
apply during the third step of the at least one following iteration k+1, by the heat treatment head via the balancing controller to the rotor and in the presence of the vibration V measured by the at least one rotor vibration sensor, the heating power
Pₖ₊₁=r·Hₖ₊₁·Vₖ₊₁·e^{j·(α}^{ₖ₊₁}^{+β}^{ₖ₊₁}⁾
where Vₖ₊₁ is the amplitude of the vibration V of the rotor, having been measured during the first step of the at least one following iteration k+1.

9. The method according to claim 8, wherein the prescribed increasing function is a linear ramp increasing as a function of time up to the prescribed threshold Hₘₐₓ or an affine ramp increasing as a function of time up to the prescribed threshold Hₘₐₓ.

10. The method according to claim 1, wherein the method further includes the following steps, carried out by the balancing controller before the first step, the second step and the third step:
identifying a pair of a target value H_{c} of the adjustment parameter H and of a target value ß_{c} of the adjustment parameter ß, which is located in the at least one stable area of the at least one prescribed rotor stability map and which gives the smallest value of the vibration reduction factor Fᵣ, strictly less than 1, among a finite set of determined values of the vibration reduction factor Fᵣ,
identifying a pair of a starting value Ha of the adjustment parameter H and of a starting value ß_{d} of the adjustment parameter ß, which is located in the at least one stable area of the at least one prescribed rotor stability map and for which the vibration reduction factor Fᵣ is strictly less than 1, the starting value H_{d} of the adjustment parameter H being smaller than the target value H_{c} of the adjustment parameter H,
identifying in the at least one prescribed rotor stability map a path going from the pair of H_{d} and ß_{d} to the pair of H_{c} and ß_{c} by successive pairs of the values of Hₖ and ßₖ, which are located in the at least one stable area of the at least one prescribed rotor stability map,
the first step, the second step and the third step being carried out iteratively for the successive pairs of the values of Hₖ and ßₖ to go from the pair of H_{d} and ß_{d} to the pair of H_{c} and ß_{c}.

11. The method according to claim 10, wherein the method further includes, before the first step, the second step and the third step, a step of choosing a total, non-zero duration, tₘ to go from the pair of H_{d} and ß_{d} to the pair of H_{c} and ß_{c}, carried out by the balancing controller.

12. The method according to claim 1, wherein the first step, the second step and the third step are carried out iteratively for at least one previous iteration k and at least one following iteration k+1, in order to:
if k=0 or Vₖ₊₁>Vₖ, identify by the balancing controller during the second step of the at least one following iteration k+1 the value Hₖ₊₁ of the adjustment parameter H and the value βₖ₊₁ of the adjustment parameter ß, which are located in the at least one stable area of the at least one prescribed rotor stability map,
and otherwise identify by the balancing controller during the second step of the at least one following iteration k+1 the value Hₖ₊₁ of the adjustment parameter H and the value βₖ₊₁ of the adjustment parameter ß with Hₖ₊₁=Hₖ and ßₖ₊₁=ßₖ.

13. The method according to claim 1, wherein the at least one rotor vibration sensor includes m rotor vibration sensors cᵢ which are mounted on the stator, where m is a natural number greater than or equal to 2 and i is an integer ranging from 1 to m,
the method further includes the following steps, before the first, second and third steps:
during a first preparatory step, measuring a complex vibration measurement vector
$${Q}_{d} = {\{ {q}_{{d}_{i}} {e}^{j {γ}_{{d}_{i}}} \}}^{T}$$
by the m rotor vibration sensors cᵢ, where q_{d}_{ᵢ} is the amplitude of the vibrations of the rotor measured respectively by the rotor vibration sensor cᵢ and γ_{d}_{ᵢ} is the phase of the vibrations of the rotor measured respectively by the rotor vibration sensor cᵢ,
during a second preparatory step, calculating the at least one prescribed rotor stability map in association with values of the vibration reduction factor Fᵣ by repeating the following sub-steps for each value of H and β located in the at least one stable area of the at least one prescribed rotor stability map by the balancing controller:
calculating Q_{f} being solution of the system of equations:
Ξ·Q_{f}=Q_{d}
with
$${Q}_{f} = {\{ {q}_{{f}_{i}} {e}^{j {γ}_{{f}_{i}}} \}}^{T}$$
calculating the values Fᵣ (H, ß) of the vibration reduction factor Fᵣ such that:
$${F}_{r} ( H , β ) = max ( {\{ \frac{{q}_{{f}_{i}}}{{q}_{{d}_{i}}} \}}_{i ∈ [ 1 , m ]} )$$
where the matrix Ξ is calculated as follows:
calculating a first matrix A such that A=−M·Ω²+j·Ω·C+K
the rotating machine being represented by a finite element model, including models of finite elements, in which the heat treatment head is located between a node Ng of a machine mesh and a node Nd of the machine mesh and the rotor vibration sensor cᵢ is located facing a node Nc of the machine mesh,
where M is a prescribed mass matrix of the finite element model of the rotating machine,
C being a prescribed damping matrix of the finite element model of the rotating machine,
K being a prescribed stiffness matrix of the finite element model of the rotating machine,
Ω being the at least one determined rotation speed,
calculating a second matrix Π of binding of degrees of freedom, the second matrix Π having the following values:
value 1 in its row tdry1, column tx,
value j in its row tdry1, column ty,
value j in its row tdrx1, column tx,
value −1 in its row tdrx1, column ty,
value −1 in its row tdry2, column tx,
value −j in its row tdry2, column ty,
value −j in its row tdrx2, column tx,
value 1 in its row tdrx2, column ty,
0 elsewhere,
where j is the complex number being square root of −1,
X is a first direction perpendicular to the axis of rotation,
Y is a second direction perpendicular to the first direction X and to the axis of rotation,
tx is an index of a translational displacement degree of freedom along the first direction X of the node Nc,
ty is an index of a translational displacement degree of freedom along the second direction Y of the node Nc,
tdrx1 is an index of a rotational displacement degree of freedom around the first direction X of the node Ng,
tdry1 is an index of a rotational displacement degree of freedom around the second direction Y of the node Ng,
tdrx2 is an index of a rotational displacement degree of freedom around the first direction X of the node Nd,
tdry2 is an index of a rotational displacement degree of freedom around the second direction Y of the node Nd,
calculating a third transition matrix R, having m rows and n columns, where:
i is an index for the rows of the third transition matrix R, as well as respectively for the rotor vibration sensors cᵢ and ranges from 1 to m,
n is a number of degrees of freedom of the finite element model,
tᵢ is an index for the columns of the third transition matrix R, as well as for the displacement degrees of freedom corresponding respectively to the rotor vibration sensors cᵢ, for ranging from 1 to m,
the third transition matrix R having the following values:
R(i, tᵢ)=1 for i ranging from 1 to m,
0 elsewhere,
calculating the matrix Ξ, having m rows and n columns, where:
Ξ=R·(I−H·e^{jβ}·A⁻¹·Π)
where A⁻¹ is the inverse matrix, having been calculated, of the first matrix A.

14. A rotating machine including:
a stator,
a rotor able to rotate about an axis of rotation relative to the stator, at least one rotor vibration sensor, the at least one rotor vibration sensor being mounted on the stator,
at least one heat treatment head, which occupies a determined angular range of less than 360° about the axis of rotation facing the rotor, which is without contact with the rotor and which is able to apply a heating power to the rotor without contact with the rotor in the determined angular range, being mounted on the stator,
at least one sensor of a first angular position in rotation of the rotor about the axis of rotation relative to the stator being mounted on the stator,
a balancing controller for balancing the rotor,
wherein
the heating power being a complex number having a positive modulus representing a heating amplitude applied by the at least one heat treatment head, the complex number having an argument representing a second angular position at which the heating amplitude is applied by the at least one heat treatment head in the determined angular range,
the balancing controller for balancing the rotor is able to adjust the heating power P=r·H·Ve^{jβ}
where H is an adjustment parameter for an amplitude of a bending moment created by the at least one heat treatment head and is a real greater than or equal to zero,
ß is an adjustment parameter for a phase of the heating power,
r is a coefficient of bending sensitivity of the rotor to the heating power applied by the at least one heat treatment head, the r of bending sensitivity being pre-recorded in the balancing controller,
at least one prescribed rotor stability map for at least one determined rotation speed of the rotor about the axis of rotation relative to the stator and for at least one axial position of the at least one heat treatment head, being pre-recorded in the balancing controller and indicating at least one stable area and at least one unstable area for pairs of values of H and ß, the at least one prescribed rotor stability map being parameterized by a vibration reduction factor Fᵣ determined at least in the at least one stable area,
the balancing controller for balancing the rotor and the at least one rotor vibration sensor being configured to implement at least the following steps, carried out iteratively during the rotation of the rotor about the axis of rotation relative to the stator at the at least one determined rotation speed, in order to, at each at least one previous iteration k:
during a first step, measure, by the at least one rotor vibration sensor, an amplitude Vₖ of a vibration V of the rotor and a phase αₖ of the vibration V of the rotor relative to a phase reference according to the equation V=Vₖ·e^{j·α}^{ₖ},
during a second step, identify a value Hₖ of the adjustment parameter H and of a value ßₖ of the adjustment parameter ß, which are located in the at least one stable area of the at least one prescribed rotor stability map and for which Fᵣ<1, by the balancing controller,
during a third step, apply the heating power Pₖ=r·Hₖ·Vₖ·e^{j·(α}^{ₖ}^{+β}^{ₖ}⁾ by the at least one heat treatment head via the balancing controller to the rotor and in the presence of the vibration V measured by the at least one rotor vibration sensor.

15. A computer program, including code instructions for the implementation of at least the second step and the third steps of the method for balancing the rotor of a rotating machine according to claim 1, when the computer program is executed on a controller.
